(19) United States
(12) Patent Application Publication
(10) Pub. No.: US 2015/0341892 A1
(43) Pub. Date: Nov. 26, 2015

(54) POSITIONING WITH ACCESS NETWORK QUERY PROTOCOL NEIGHBOR REPORTS

(71) Applicant: QUALCOMM Incorporated, San Diego, CA (US)

(72) Inventor: Carlos Horacio ALDANA, Mountain View, CA (US)

(21) Appl. No.: 14/494,411

(22) Filed: Sep. 23, 2014

Related U.S. Application Data
(60) Provisional application No. 62/002,543, filed on May 23, 2014.

(51) Int. Cl. H04W 64/00; H04W 4/02

(52) U.S. Cl. CPC H04W 64/00; H04W 4/025

(57) ABSTRACT

Techniques for determining the position of a client station based on Access Network Query Protocol (ANQP) neighbor reports are disclosed. An example of a wireless transceiver system for providing a neighbor report in an ANQP query response message a memory, at least one processor operably coupled to the memory and configure to determine neighbor position information, receive an ANQP query request from a client station prior to performing a wireless client association process, generate a neighbor report, and send an ANQP query response including the neighbor report to the client station. The neighbor report may be ordered and the client station may be configured to initiate Fine Timing Measurement (FTM) sessions based on the order of the station within the neighbor report.

### CROSS-REFERENCE TO RELATED APPLICATIONS

This application claims the benefit of U.S. Provisional Application No. 62/002,543, entitled “Positioning with Access Network Query Protocol Neighbor Reports,” filed on May 23, 2014, which is assigned to the assignee hereof and the contents of which are incorporated herein by reference in their entirety.

### BACKGROUND

Embodiments of the inventive subject matter generally relate to the field of wireless communication and, more particularly, to determining a position of a mobile device based on a response to an Access Network Query Protocol (ANQP) request.

Various positioning techniques can be employed for determining the position of a wireless communication device (e.g., a wireless local area network (WLAN) device) based on receiving wireless communication signals. For example, positioning techniques can utilize one or more Fine Timing Measurement (FTM) sessions between a mobile device and one or more access points. The positioning techniques may utilize time of arrival (TOA), the round trip time (RTT) of wireless communication signals, received signal strength indicator (RSSI), or the time difference of arrival (TDOA) of the wireless communication signals to determine the position of a wireless communication device in a wireless communication network. These factors may be used in conjunction with the known positions of one or more stations in the wireless network to derive the location of the wireless communication device.

### SUMMARY

An example of a wireless transceiver system for providing a neighbor report in an Access Network Query Protocol (ANQP) query response message according to the disclosure includes: a memory, at least one processor operably coupled to the memory and configure to determine neighbor position information, receive an ANQP query request from an unattached client station, and send an ANQP query response including the neighbor report to the unattached client station.

Implementations of such a wireless transceiver system may include one or more of the following features. The at least one processor may be configured to retrieve the neighbor position information from a remote server. A beacon transmission including position information may be received from a neighboring transceiver, and the at least one processor may be configured to determine the neighbor position information based on the beacon transmission. The neighbor report may include a visitation index and/or a signal strength value associated with each of one or more neighboring access points included in the neighbor report. The wireless transceiver system may generate the neighbor report, or may retrieve the neighbor report from a remote server.

An example of a method for providing a neighbor report in an Access Network Query Protocol (ANQP) query response message includes determining neighbor position information, generating the neighbor report based on the neighbor position information, receiving an ANQP query request from an unattached client station, and sending an ANQP query response including the neighbor report to the unattached client station.

Implementations of such a method may include one or more of the following features. Determining the neighbor position information may include retrieving the neighbor position information from a remote server. A beacon transmission may be received from a neighboring transceiver, such that the beacon transmission includes position information associated with the neighboring transceiver. The neighbor report may include a visitation index and/or a signal strength value associated with each of one or more neighboring access points included in the neighbor report. Generating the neighbor report may include retrieving the neighbor report from a remote server.

An example of a method of determining a location of a client station in a wireless network according to the disclosure includes sending, with the client station, an Access Network Query Protocol (ANQP) query request to a first access point, such that the client station is unattached to the first access point, receiving, with the client station, an ANQP query response including a neighbor report from the first access point, initiating, with the client station, one or more Fine Timing Measurement (FTM) sessions with one or more access points passed on the neighbor report, and determining the location of the client station based on the one or more FTM session.

Implementations of such a method may include one or more of the following features. The neighbor report may include an ordered list of neighboring access points, and the FTM sessions may be initiated in a sequence based on the ordered list of neighboring access points. The ordered list of neighboring access points may include a visitation index and/or signal strength value associated with each of one or more neighboring access points included in the ordered list of neighboring access points. The one or more FTM sessions may be initiated in a sequence based on the visitation index and/or signal strength value. The location may be displayed on the client station. Round Trip Time (RTT) information may be determined based on the FTM sessions, and the location of the client station may be determined based on the RTT information.

An example of an apparatus according to the disclosure includes a memory, at least one processor operably coupled to the memory and configure to send an Access Network Query Protocol (ANQP) query request to a first access point, wherein the apparatus is unattached from the first access point, receive an ANQP query response including a neighbor report from the first access point, initiate one or more Fine Timing Measurement (FTM) sessions with one or more access points based on the neighbor report, and determine a location of the apparatus based on the one or more FTM sessions.

Implementations of such an apparatus may include one or more of the following features. The neighbor report may include an ordered list of neighboring access points, and processor may be configured to initiate the FTM sessions in a sequence based on the ordered list of neighboring access points. The ordered list of neighboring access points may include a visitation index. The ordered list of neighboring access points may include a signal strength value associated with each of one or more neighboring access points included the ordered list of neighboring access points. The apparatus may include a display screen, such that the at least one processor is further configured to output the location to the display screen. The at least one processor may be configured to determine Round Trip Time (RTT) information based on the one or more FTM sessions, and determine the location of the apparatus based on the RTT information.

Items and/or techniques described herein may provide one or more of the following capabilities, as well as other capabilities not mentioned. Positioning of mobile network devices may be realized. Client station message traffic may be reduced. Access point neighbor report information may be delivered to an unattached client station (e.g., prior to performing a wireless client association process). Network message traffic may be reduced. Further, it may be possible for an effect noted above to be achieved by means other than that noted, and a noted item/technique may not necessarily yield the noted effect.

### BRIEF DESCRIPTION OF THE DRAWINGS

FIG. 1A is an example block diagram of a wireless local area network for determining the position of a client station with access network query protocol neighbor reports.

FIG. 1B is an example network diagram of a wireless local area communication network including a position server.

FIG. 2 is a conceptual diagram of the use of multiple ANQP message exchanges in the prior art.

FIG. 3 is an example of a conceptual diagram of an ANQP message exchange and subsequent Fine Timing Message (FTM) Sessions.

FIG. 4 is an exemplary FTM Session.

FIG. 5 includes examples of ANQP neighbor report frames.

FIG. 6 is flow diagram of a process for sending an ANQP query response with a neighbor report.

FIG. 7 is flow diagram of a process for determining the position of a client station.

FIG. 8A a block diagram of an electronic device for use in positioning utilizing ANQP neighbor reports.

FIG. 8B is a block diagram of an exemplary access point.

### DETAILED DESCRIPTION

The description that follows includes exemplary systems, methods, techniques, instruction sequences, and computer program products that embody techniques of the present inventive subject matter. However, it is understood that the described embodiments may be practiced without these specific details. For instance, although examples utilize Access Network Query Protocol Neighbor reports for positioning wireless local area network (WLAN) devices, embodiments are not so limited. In other embodiments, the positioning information may be provided by other wireless standards and devices (e.g., WiMAX devices). In other instances, well-known instruction instances, protocols, structures, and techniques have not been shown in detail in order not to obfuscate the description.

In wireless communication networks, determining the position of an electronic device with wireless communication capabilities (e.g., within an indoor or outdoor environment) can be a desired feature for users of the communication device (e.g., mobile phone users) and operators of the wireless communication network. In some systems, round-trip time (RTT) techniques can be implemented for determining the position of the communication device. For example, the communication device can transmit a request message to multiple access points and can receive a response message from each of the access points. The range between the communication device and each of the access points can be determined by measuring the round trip time between the request messages and the corresponding response messages. The position of the communication device can be determined by comparing the RTT information to the known locations of the access points. In some systems, time difference of arrival (TDOA) techniques can be implemented for determining the position of the communication device. For example, the communication device can determine its position based on the difference between the ranges from each of the access points to the communication device. A mobile communication device may initiate RTT positioning operations (or the TDOA positioning operations) by transmitting a request message to one or more access points. In an embodiment, a message request is proceeded by an Access Network Query Response Protocol ANQP query request and response for each access point. Access Network Query Response Protocol (ANQP) is a protocol used to define and/or access services offered by an access point, communicating metadata such as that used during network selection and association or that used in ranging and/or positioning, as discussed below. In an embodiment, the ANQP protocol may be used to access information regarding neighboring access points. Because the mobile communication device may initiate an RTT positioning operation with multiple access points, the overhead required for the preceding ANQP query request and response may consume a substantial amount of bandwidth and power. Moreover, if a wireless communication network comprises multiple such communication devices, such as in a crowded sports stadium or other popular venue, each communication device may be required to perform an ANQP query request prior to executing an RTT positioning operation (or a TDOA positioning operation), thus increasing the traffic load in the wireless communication network.

A communication device can be configured to send an ANQP query request while unattached from an access point. For example, the ANQP query request may be sent prior to performing an association procedure with an access point. The ANQP query request may include one or more elements such as a query list, vendor specific elements, Tunnel Direct Link Setup (TDLS), or other elements as defined by network specifications (e.g., IEEE 802.11, Table 10-16). In an embodiment, the corresponding ANQP query response may include a list of one or more access points in a neighbor report. The neighbor report may include ordinal, signal and position information (e.g., Visitation index, Signal Strength value, Latitude value, Longitude value, Altitude, Z axis information, Civic location information) for each access point. A communication device may initiate a Fine Timing Measurement (FTM) session with the access points in the neighbor report. The FTM session may be used to determine RTT and/or TDOA timing information associated with the respective access points. A position calculation unit in the communication device may determine the position of the communication device based on RTT and/or TDOA information derived from the FTM session. The communication device can be configured to select the one or more access points for use in the position determining. The selection and sequence of the access points may be based on information included in the ANQP response such as a visitation index, signal strength information, location information, or other variables in the neighbor report. The initiation of the FTM sessions between the communication device and the access points is based on the neighbor report provided in a single ANQP response. A positioning process utilizing ANQP neighbor reports may reduce the overhead associated with multiple ANQP request and response transactions. This may minimize the impact of the communication device transmissions on the traffic load of the wireless communication network.

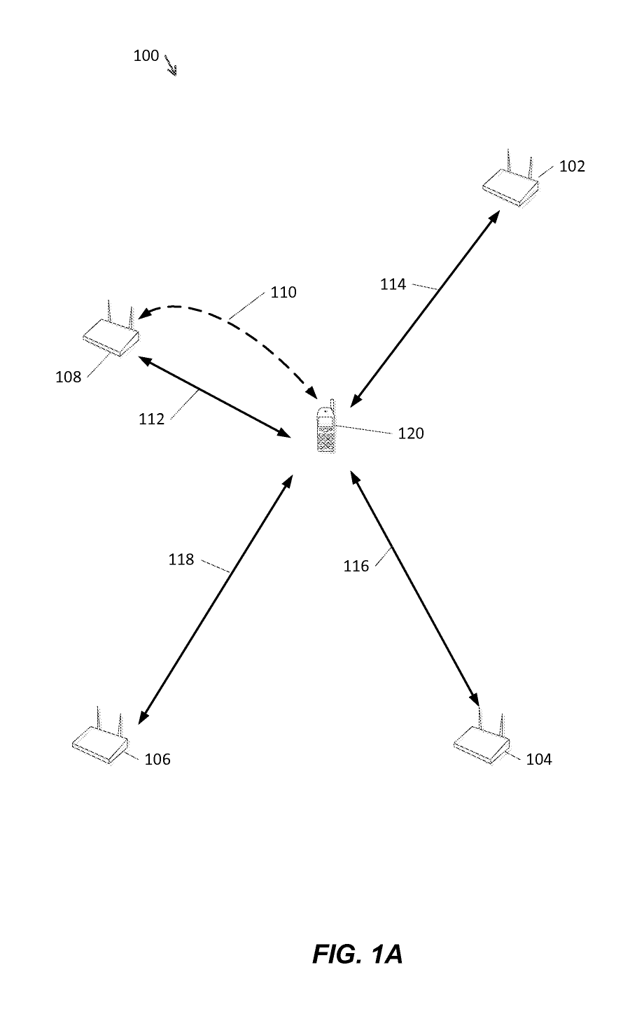

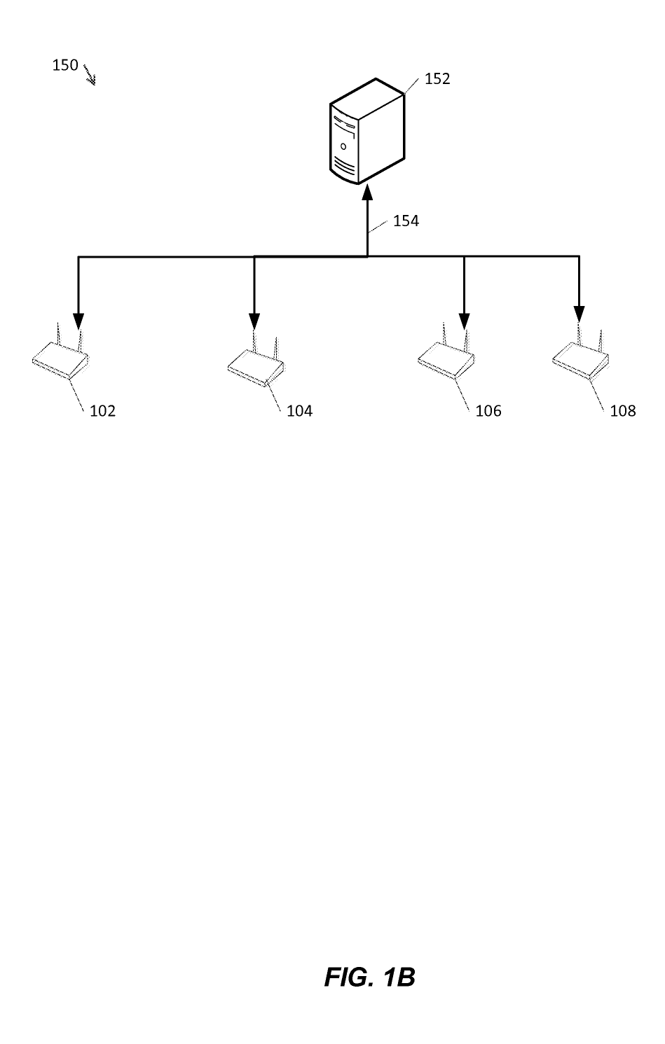

Referring to FIG. 1A, an example block diagram of a wireless communication network 100 for determining the position of a client station with access network query protocol neighbor reports is shown. The wireless communication network 100 includes four access points 102, 104, 106, 104 and a client station 120. The access points 102, 104, 106, 108 may be an advanced WLAN access points capable of determining their own positions (e.g., a self-locating access point). The access points may be configured to communicate with one or more other access points in the wireless communication network 100 (e.g., within the communication range of one another). In some implementations, access points can be arranged that one access point can be designated as a master access point, and the other access points can be designated as target access points. The client station 120 can be any suitable electronic device (e.g., a notebook computer, a tablet computer, a netbook, a mobile phone, a gaming console, a personal digital assistant (PDA), inventory tag, etc.) with WLAN communication capabilities. Furthermore, in FIG. 1A, the client station 120 is within the communication range of one or more access points 102, 104, 106, 108.

The client station 120 may initiate an ANQP exchange 110 with the first access point 108. The content of the ANQP exchange 110 may conform in part to network standards (e.g., IEEE 802.11). The ANQP exchange 110 may occur while the client station 120 is unattached from the access point 108. For example, the ANQP exchange 110 may occur prior to a wireless client association process between the client station 120 and the first access point 108. In general, during the client association process, the Service Set Identification (SSID) Media Access Control (MAC) address, and security settings are sent from the client to the access point and are then checked by the access point. A client associate process may result in attaching the client station 120 to the access point 108. The ANQP exchange 110 may include an ANQP query request from the client station 120 to the first access point 108, an Acknowledgment (ACK) message from the first access point 108 to the client station 120, an ANQP query response from the first access point 108 to the client station 120, and an ACK message from the client station 120 to the first access point 108. The ANQP query response includes a neighbor report containing positioning information associated with the neighboring access points (e.g., 102, 104, 106). Upon receipt of the ANQP query response, the client station 120 may be configured to initiate one or more FTM sessions with the access points 102, 104, 106, 108. For example, a first FTM session 112 may occur between the client station 120 and the first access point 108. The client station 120 may determine position information (e.g., RTT and/or TDOA information) based on the first FTM session 112. The client station 120 may subsequently initiate a second FTM session 114 with a second access point (e.g., access point 102) based on the information included in the ANQP exchange 110. The second FTM session 114 need not be preceded by another ANQP exchange with the second access point. The client station 120 may then determine position information (e.g., RTT and/or TDOA information) based on the second FTM session 114. Additional FTM sessions may occur based on the neighbor report received during the ANQP exchange 110. The client station 120 may initiate a third FTM session 116 with a third access point (e.g., access point 104), and a fourth FTM session 118 with a fourth access point (e.g., access point 106). The timing and sequence of the FTM sessions 112, 114, 116, 118 may be based on fields within the neighbor report. For example, the neighbor report in the ANQP exchange 110 may include ordinal information, signal strength information, confidence level, and/or location information for each access point in the neighbor report. The client station 120 may be configured to determine a sequence in which to visit each of the access points based on the neighbor report.

The client station 120 may be configured to determine a position based, at least in part, on the position information included in the neighbor report. In some implementations, the client station 120 can use the access point position information (e.g., latitude, longitude, altitude), in combination with the TDOA timing information, and/or the RTT timing information to construct a “positioning equation” in terms of the range between the client station 120 and each of the predetermined number of access points 102, 104, 106, 108. For example, on determining the access point position information, the TDOA timing information, and the RTT timing information associated with three target access points, the client station 120 can solve three positioning equations to determine a three-dimensional position of the client station 120. It is noted that in other implementations, the client station 120 can determine a position based on the access point position information, the TDOA timing information, and the RTT timing information associated with any suitable number of access points. For example, a position can be based on two independent positioning equations from the access point position information, the TDOA timing information, and the RTT timing information associated with two target access points to determine a two-dimensional position of the client station 120.

Referring to FIG. 1B, an example network diagram of a wireless local area network including a position server is shown. The network 150 includes access points 102, 104, 106, 108, a position server 152, and a communication path 154. The position server 152 is a computing device including at least one processor and a memory and is configured to execute computer executable instructions. For example, a position server 152 comprises a computer system including a processor, non-transitory memory, disk drives, a display, a keyboard, a mouse. The processor is preferably an intelligent device, e.g., a personal computer central processing unit (CPU) such as those made by Intel® Corporation or AMD®, a microcontroller, an application specific integrated circuit (ASIC), etc. The memory includes random access memory (RAM) and read-only memory (ROM). The disk drives include a hard-disk drive, a CD-ROM drive, and/or a zip drive, and may include other forms of drives. The display is a liquid-crystal display (LCD) (e.g., a thin-film transistor (TFT) display), although other forms of displays are acceptable, e.g., a cathode-ray tube (CRT). The keyboard and mouse provide data input mechanisms for a user. The position server 152 stores (e.g., in the memory) processor-readable, processor-executable software code containing instructions for controlling the processor to perform functions described herein. The functions may assist in the implementation of positioning with access network query protocol neighbor reports. The software can be loaded onto the memory by being downloaded via a network connection, uploaded from a disk, etc. Further, the software may not be directly executable, e.g., requiring compiling before execution. The access points 102, 104, 106, 108 are configured to communicate with the position server 152 to exchange position information via the communication path 154. The communication path 154 can be a wide area network (WAN) and can include the internet. The position server 152 can include a data structure (e.g., relational database, flat files) to store access point neighbor information. For example, the position server 152 can include access point position information (e.g., lat./long., x/y), RTT information, SIFS information, and other information associated with an access point (e.g., SSID, MAC address, uncertainty value, coverage area, etc.). An access point (e.g., 102, 104, 106, 108) may communicate with the position server 152 and can retrieve, for example, access point neighbor information, SIFS information and RTT information for use in client station positioning solutions. The configuration of the position server 152 as a remote server is exemplary only and not a limitation. In an embodiment, the position server 152 may be connected directly to an access point, or the functionality may be included in an access point. More than one position servers may be used. The position server 152 can include one or more databases containing position information associated with other access points on additional networks. In an example, the position server 152 is comprised of multiple server units.

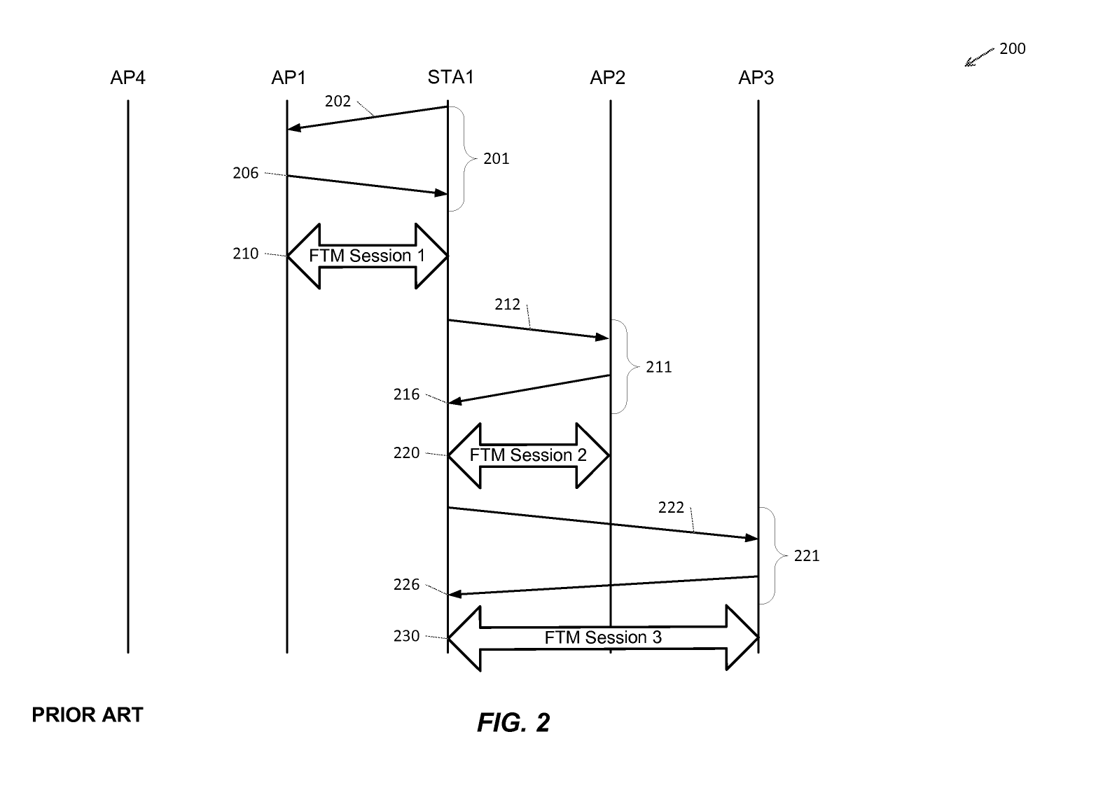

Referring to FIG. 2, a conceptual diagram 200 of the use of multiple ANQP message exchanges in the prior art is shown. The conceptual diagram 200 includes four access points (e.g. AP1, AP2, AP3, AP4) and a mobile device (e.g., STA1). The mobile device may initiate a first ANQP exchange 201 with AP1 by sending an AP1 ANQP query request 202, AP1 may respond with an AP1 ANQP query response 206. The AP1 ANQP query response 206 does not include a neighbor report. In general, the methods and systems in the prior art do not provide neighbor information to an unattached mobile device. Upon completion of the ANQP exchange with AP1, the mobile device will initiate an AP1 FTM session 210. The mobile device may then initiate a second ANQP exchange 211 with a second AP (e.g., AP2). The messages in the ANQP exchange with AP2 are substantially similar to the messages in the ANQP exchange with AP1. That is, the mobile device will send an AP2 ANQP query request 212, and receive an AP2 ANQP query response 216. After the second ANQP exchange 211, the mobile device will initiate a second FTM session 220.

The pattern of ANQP exchanges and FTM sessions may repeat for each access point. As depicted in the conceptual diagram 200, the mobile device may initiate a third ANQP exchange 221, including an AP2 ANQP query request 222 and an AP3 ANQP query response 226. At the completion of the third ANQP exchange 221, a third FTM session 230 may be initiated. The prior art system of FIG. 2 includes multiple exchanges that may be eliminated by the use of ANQP messages with neighbor reports as described herein.

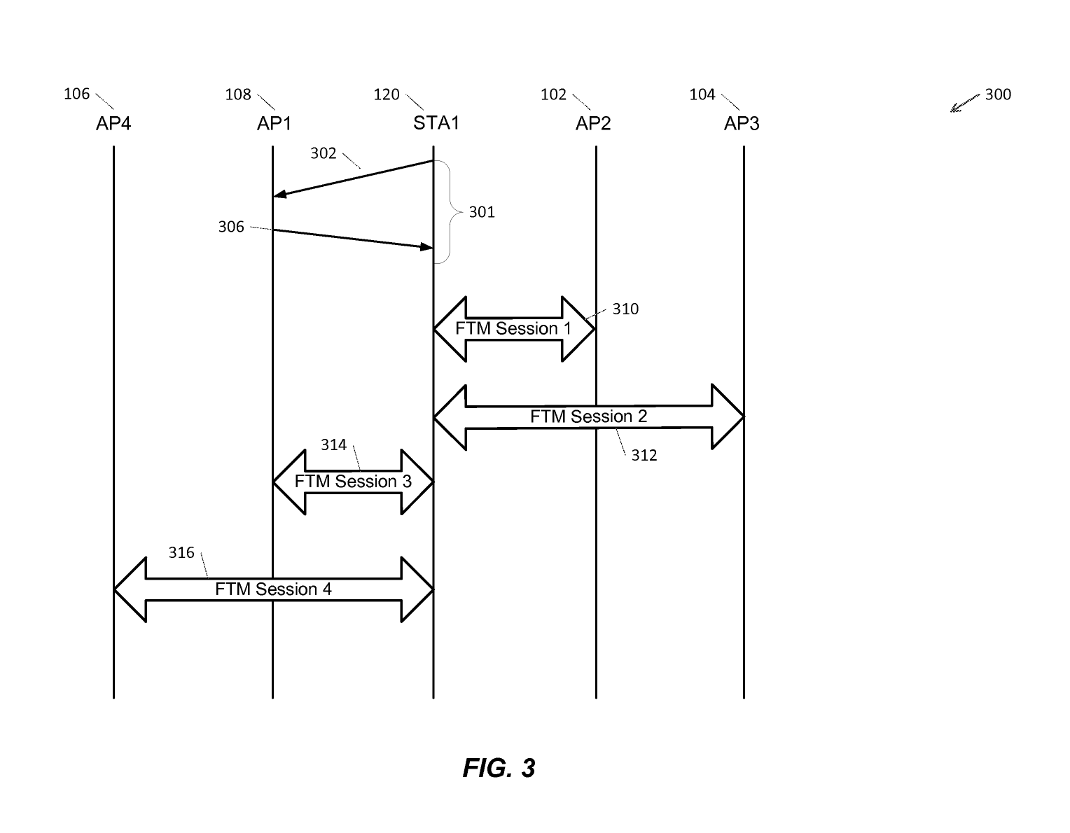

Referring to FIG. 3, a message flow diagram 300 of an ANQP message exchange and subsequent Fine Timing Measurement (FTM) Sessions is shown. The message flow diagram 300 is based on the elements of the wireless communication network 100, and includes four access points 102, 104, 106, 108, and a client station 120. In an embodiment, the client station 120 may be an access point and the message flow diagram 300 may be used in determining the location of an access point in a wireless network. The client station 120 may initiate a single ANQP exchange 301 with an access point (e.g., the first access point 108). The single ANQP exchange 301 may occur with an unattached client station 120. For example, the ANQP exchange 301 may occur prior to performing a wireless client association process between the client station 120 and an access point. The single ANQP exchange 301 may include an ANQP query request 302 from the client station 120 to the access point. The access point may then send an ANQP query response with a neighbor report 306. The ANQP query response with a neighbor report 306 may include a number of frames such as generally described in the industry standard protocols (e.g., IEEE 802.11). The frames, and associated fields, include information about the neighboring access points (e.g., 102, 104, 106). The client station 120 is configured to parse the received frames and store the respective information (i.e., fields) in the frames. The client station 120 may then initiate one or more FTM sessions with the one or more access points included in the ANQP query response with a neighbor report 306. The order and sequence of the FTM sessions may be based on the information in the ANQP query response with a neighbor report 306, or may be determined by the client station 120. For example, the client station 120 may include locally stored history files and almanac data, and prefer to communicate with previously visited access points (e.g., based on a confidence level field).

In an example, upon receiving the neighbor report information, the client station 120 may conduct a first FTM session 310 with the second access point. At the conclusion of the first FTM session 310, the client station 120 may conduct a second FTM session 312 with a third access point. The second FTM session 312 follows the first FTM session 310 without the need for an intervening ANQP message exchange. That is, the client station 120 utilizes the neighbor information obtained in the single ANQP exchange 301 to perform the first and second FTM exchanges. Similarly, the client station 120 may perform a third FTM session 314 with the first access point 108 (for example), and then conduct a fourth FTM session 316 with a fourth access point. As indicated in the message flow diagram 300, multiple FTM sessions (e.g., 310, 312, 314, 316) may occur based on the single ANQP exchange 301. The ANQP query response with a neighbor report 306 in the single ANQP exchange 301 reduces the need for the second, third and subsequent ANQP exchanges described in FIG. 2, and thus may greatly reduce the message overhead in the wireless communication network 100.

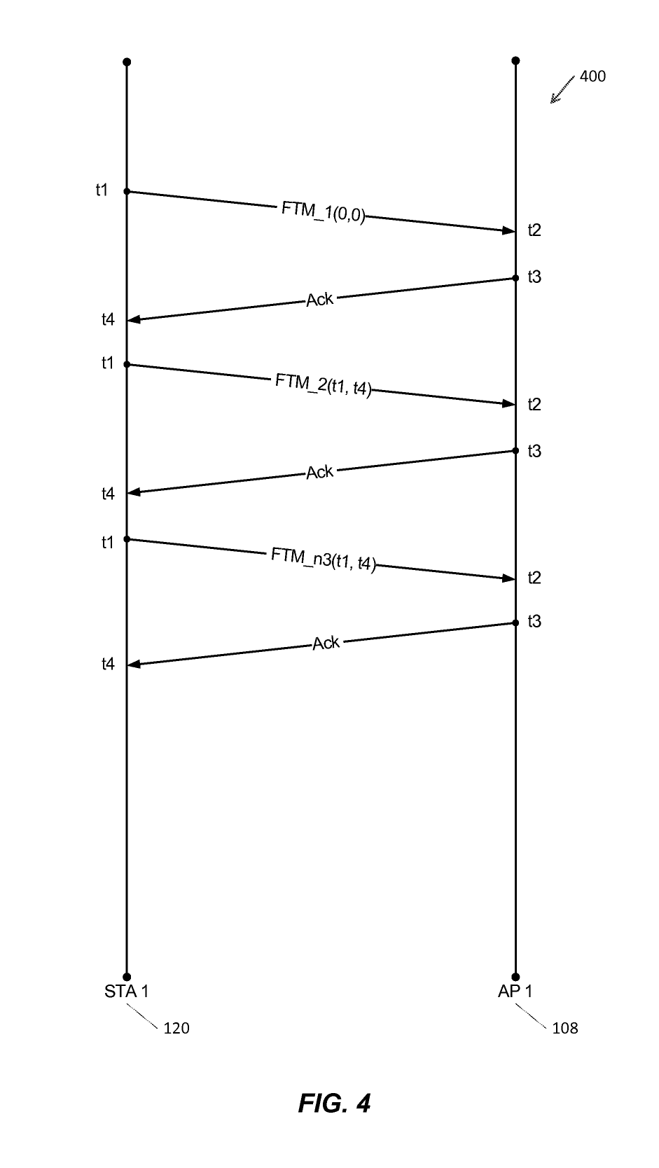

Referring to FIG. 4, an example of a conceptual diagram of a Fine Timing Measurement (FTM) session 400 is shown. The general approach includes a client station 120 (e.g., STA1) and a first access point 108 (e.g., AP1). The client station 120 and the first access point 108 may be any of access points 102, 104, 106, 108. As a general distinction, an access point may serve multiple stations but the terms as used herein are not so limited. The relevant operations described herein may be performed on both stations and access points. The FTM session 400 may allow the client station 120 to obtain its range with the first access point 108. The client station 120 may perform this procedure with multiple other access points in order to obtain its location. An FTM session is an instance of a fine timing measurement procedure between the client station 120 and the first access point 108, and may include the associated scheduling and operational parameters of that instance. An FTM session is generally composed of a negotiation, a measurement exchange, and a termination. An access point may participate in multiple concurrent FTM sessions. Concurrent FTM sessions may occur with responding stations that are members of different Basic Service Sets (BSS) and possibly different Extended Service Sets (ESS), or possibly outside of a BSS, each session using its own scheduling, channel and operational parameters. A responding access point may be required to establish overlapping FTM sessions with a large number of initiating client stations (e.g. the first access point 108 providing measurements to multiple other client stations at stadium, a mall or a store). In an example, a client station may have multiple ongoing FTM sessions on the same or different channels with different responding access points, while being associated to a particular access point for the exchange of data or signaling. In an example, the client station is not associated with any access point. To support the constraints of both the access points, during the negotiation the client station 120 initially requests a preferred periodic time window allocation. The first access point 108 subsequently responds by accepting or overriding the allocation request based on its resource availability and capability. Since some of the client station's 120 activities may be non-deterministic and may have higher precedence than the FTM session (e.g. data transfer interaction with an associated AP), a conflict may prevent the client station 120 from being available at the beginning of a burst instance determined by the first access point 108. In such an example, the client station may establish sessions with the first access point 108, and a second access point (e.g., access point 102) on different channels. Each of the sessions' burst periodicity may be different and each of the stations' clock offsets may differ. Thus, over time, some temporal conflicts may occur. To overcome this, during each burst instance the initiating station may indicate its availability by transmitting a trigger frame in the form of a Fine Timing Measurement Request frame. During each burst instance, the responding station transmits one or more fine timing measurement frames as negotiated.

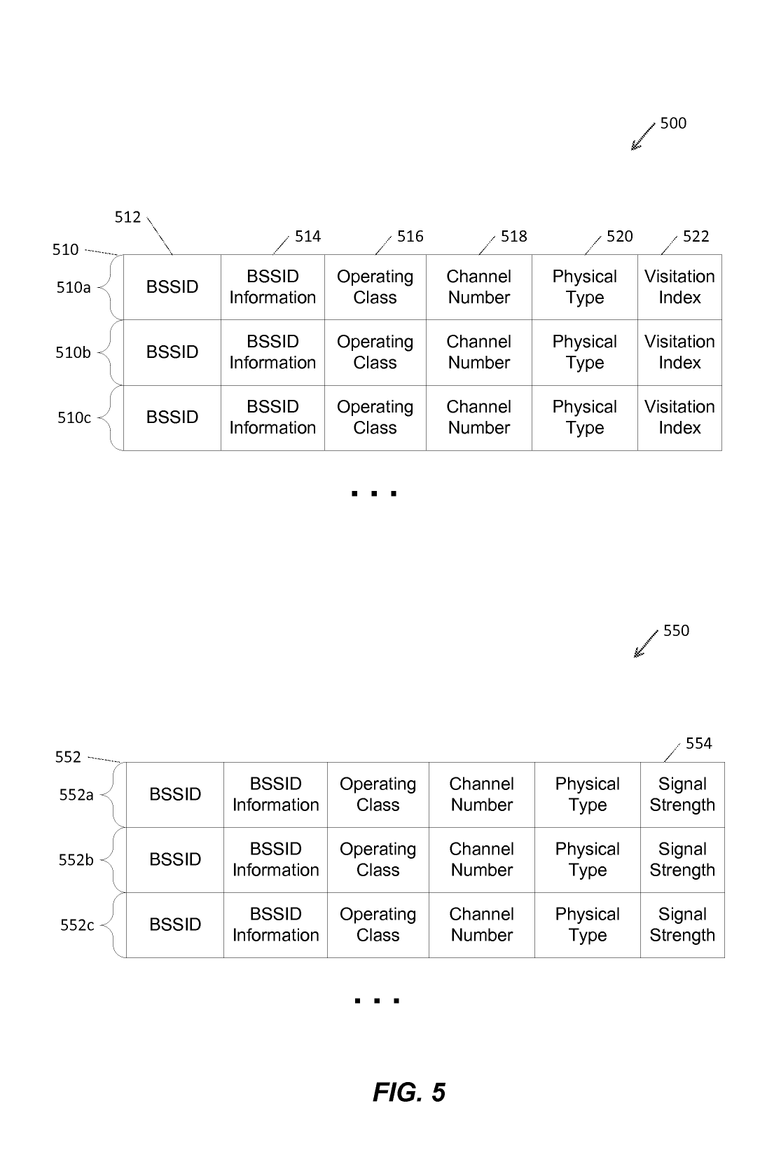

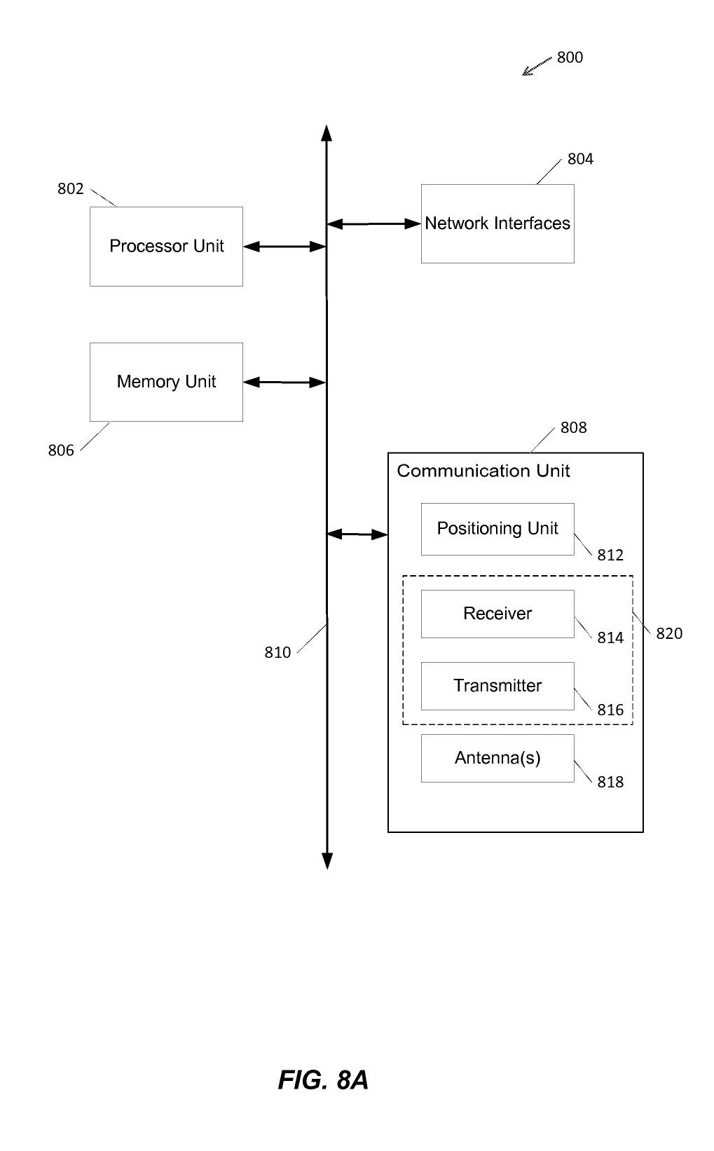

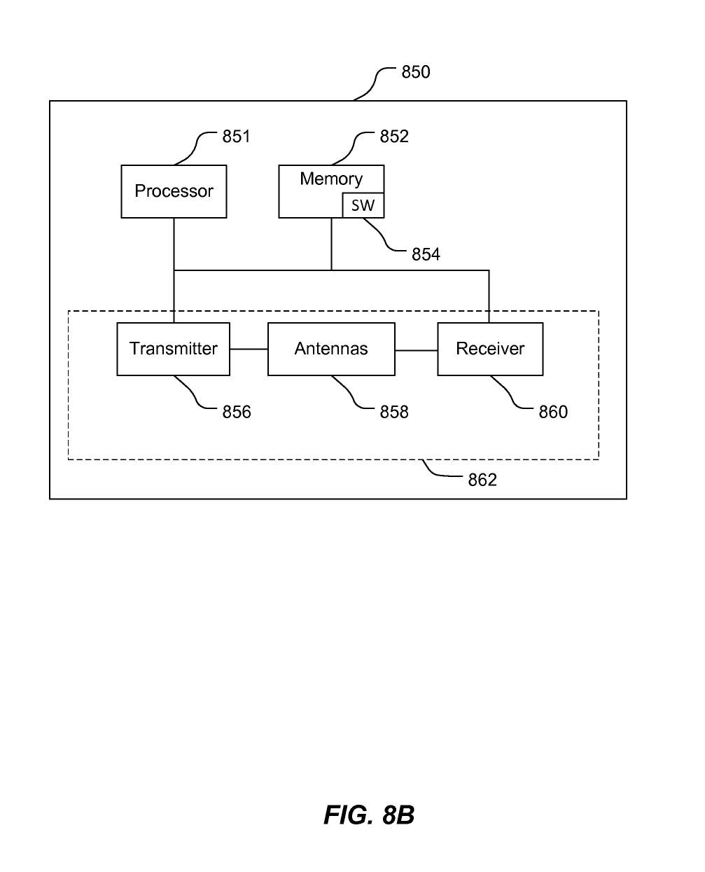

Referring to FIG. 5, with further reference to FIGS. 1A, and 3, examples of ANQP neighbor report frames are shown. A neighbor report frame with a visitation index 500 may be a MAC frame format such as generally described in the IEEE P802.11 standard, FIG. 8-255. The neighbor report frame with a visitation index 500 is included in the ANQP query response with a neighbor report 306, and thus is provided to the client station 120 in response to an ANQP query request. The neighbor report frame with a visitation index 500 may include multiple neighbor record elements 510 (e.g., 510a, 510b, 510c), with each of the multiple neighbor record elements containing information associated with a neighboring access point. The neighbor report element may contain position information (e.g., latitude, longitude, altitude) for each of the neighbors. The neighbor report frame with a visitation index 500 may be constrained to only include a sufficient list of neighboring stations to perform positioning and/or ranging. The content of the neighbor report may be influenced by both the spatial and frequency domain factors (e.g., in dual frequency band networks). The neighbor report may include on the neighboring stations which have a signal strength value above a predetermined threshold, or may include only a fixed number of neighboring stations (e.g., the stations with the highest signal strength). The access points on the neighbor report may be constrained based on an estimated location of the client station (e.g., based on a range from the estimated location). Other constraints to the number or selection of the neighboring stations may also be used. For example, the neighbor list may be constrained based on subscription information (e.g., preferred vendors), or based on current network/station load. Other fields may also be used to determine which neighboring stations to include as a neighboring station. Exemplary neighbor record elements 510 may include a Basic Service Set Identification (BSSID) field 512, a BSSID Information field 514, an operating class field 516, a channel number field 518, a physical type field 520, and a visitation index 522. Other sub-element fields may also be included. The BSSID field 512 represents the BSSID of the BSS being reported. The BSSID Information field 514 may be used to determine neighbor service set transition candidates. The operating class field 516 may be used to indicate operational frequency ranges (e.g., 2.4 GHz, 5 GHz), as well as channel spacing. The channel number field 518 may be used to provide channel center frequency information. The physical type field 520 indicates the PHY type of the access point indicted by the BSSID (e.g., ODFM, HT, DMG). The visitation index 522 indicates the priority (e.g., order) and how each of the corresponding access points are to be visited by the receiving client station. This index may prevent additional signaling once the neighbor report frame is received. For example, the client station 120 may visit (e.g., send FTM packets) to the first access point 108 (e.g., AP1). The client station 120 may then visit a second access point for a fixed amount of time, and then visit a third access point. The order of the visits may be based on the order of the visitation index in the network record elements.

A neighbor report frame with a signal strength field 550 includes neighbor record elements 552 (e.g., 552a, 552b, 552c). The neighbor record elements 552 may include fields such as described above with respect to the neighbor report frame with a visitation index 500, in addition to a signal strength field 554. The signal strength field 554 may represent the Received Signal Strength (RSS) between the respective access points. The implementation of RSS measurements may differ based on the hardware configuration of the access points. In an example, the signal strength of a Broadcast Control Channel (BCCH) may be monitored and recorded. If the client station 120 receives the ANQP query response with a neighbor report 306 from the first access point 108, then the signal strength field 554 may represent the signal strength received by the first access point 108 from the signals transmitted by the neighboring access points (e.g., 102, 014, 106). In this way, the client station 120 may use the signal strength field 554 to prioritize the subsequent FTM sessions. The signal strength field 554 may be included in the neighbor record elements with or without the visitation index 522. Other fields may also be included.

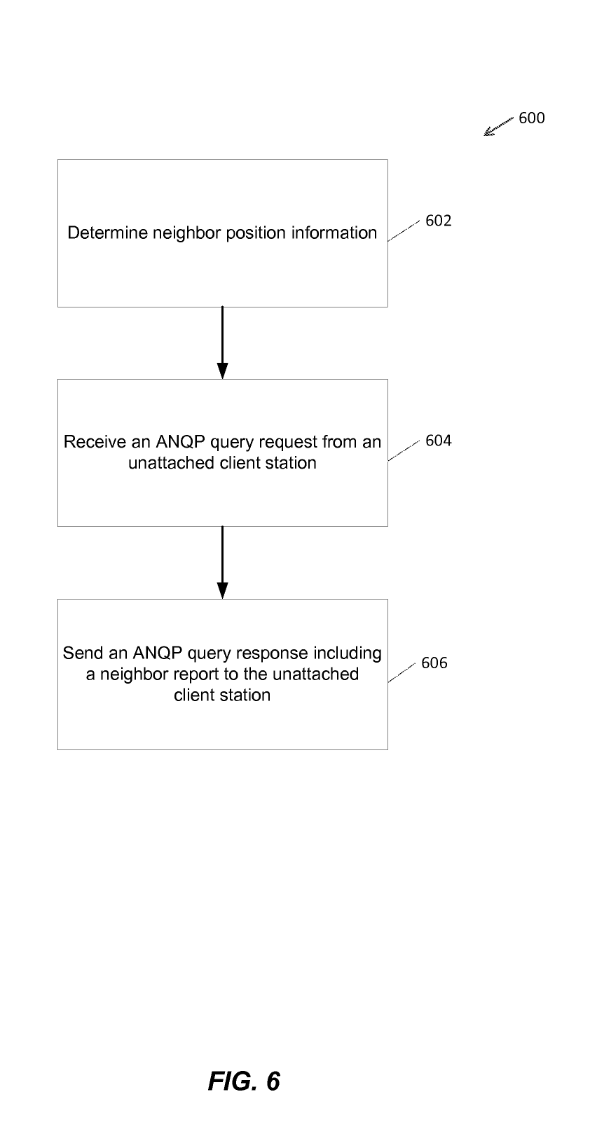

In operation, referring to FIG. 6, with further reference to FIGS. 1A, 1B, 3, and 5, a process 600 sending an ANQP query response with an neighbor report includes the stages shown. The process 600, however, is exemplary only and not limiting. The process 600 may be altered, e.g., by having stages added, removed, or rearranged.

At stage 602, the first access point 108 is configured to determine neighbor position information. The neighbor position information may include the fields and data contained in the neighbor record elements 510, 552, as well as other information that may be used for client station positioning. In an example, the position server 152 may include one or more databases to store the neighbor report information and the first access point 108 is configured to access the database on a periodic basis, or after an ANQP query request is received. The data in the position server database may be populated by a wireless network vendor, or may be provided and periodically updated by network resources. In an example, the first access point 108 may be configured to listen to beacon reports from the neighboring access points and store the appropriate fields (e.g., BSSID, location information, signal strength, etc. . . . ). The first access point 108 may be configured to store the neighbor report information locally or on the position server 152. In an example, the first access point 108 may send probe requests to the neighboring access points and then store the information contained in the subsequent responses to the probe requests. The first access point 108, or the position server 152, may be configured to determine a visitation index value for each access point in a respective neighborhood. The visitation index may be based on the received signal strength, but other factors such as the channel number, physical type, location and operating class may be used to determine a visitation index.

At stage 604, the first access point 108 is configured to receive an ANQP query request from an unattached client station 120. In an example, the ANQP request may be received by the first access point 108 prior to performing a wireless client association process with the client station 120. The first access point 108 may be characterized as an Independent Base Station (IBSS) under the (IEEE) 802.11 specifications because the received ANQP query request is received from the client station 120 before establishing an association between the first access point 108 and the client station 120. In an example, the ANQP query request may be received from a neighboring access point.

At stage 606, the first access point 108 is configured to send an ANQP query response including the neighbor report to the unattached client station. The first access point 108 may be configured to generate the neighbor report (i.e., locally), or the neighbor report may be generated on the position server 152 (i.e., remotely). In an example, the first access point 108 may order the list of neighbors by creating an index value associated with each neighbor record element. The order (e.g., index, priority) of the neighbor record elements may be used by the client station 120 to determine a visitation index. Other prioritization (i.e., ordering) requirements may also be used. The order of the neighbor list may be based on a signal strength, channel number, or physical type of the received request. Other information associated with the ANQP query request may also be used to order the neighbor list. The neighbor list may be constrained to include a subset of the neighborhood. For example, only 8 neighbors of a possible 14 neighbors are included in the neighbor report. In an example, the neighbor list is neither ordered nor constrained. The ANQP query response may be provided to an unattached client station 120 (e.g., prior to establishing an association between the first access point 108 and the client station 120). The first access point 108 may provide the neighbor report as an IBSS under the (IEEE) 802.11 specifications. The order of the neighbor report elements in the neighbor report may be used by the client station 120 to determine a sequence of FTM sessions with the access points included in the neighbor report.

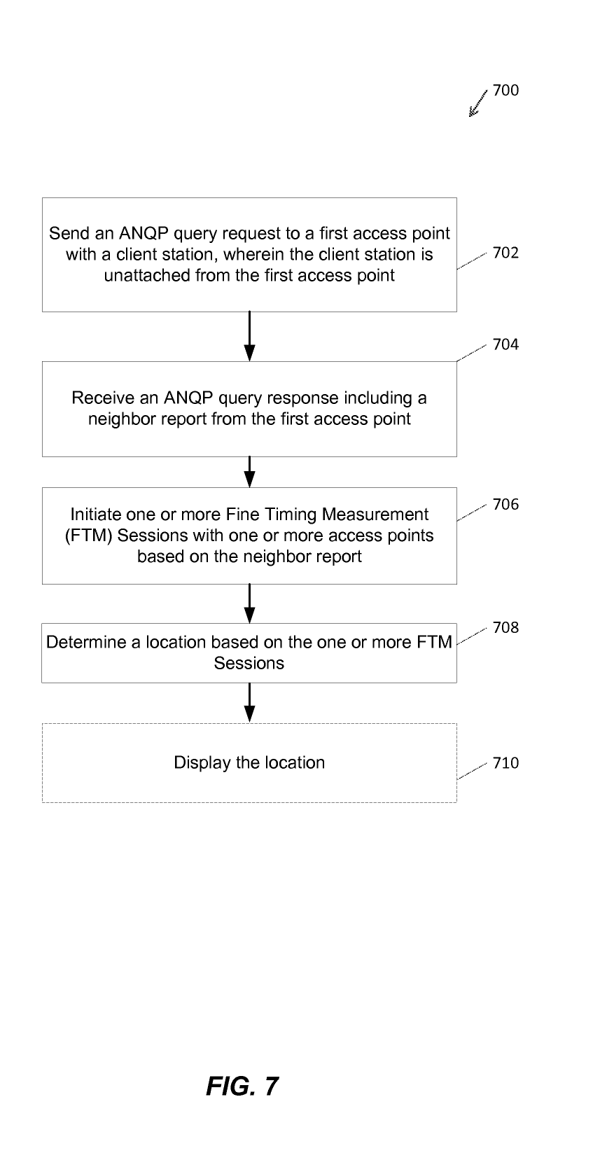

In operation, referring to FIG. 7, with further reference to FIGS. 1A, 1B, 3-5, and 6 a process 700 for determining the position of a client station includes the stages shown. The process 700, however, is exemplary only and not limiting. The process 700 may be altered, e.g., by having stages added, removed, or rearranged. For example, a position calculation can be made by the processors on the client station 120 (i.e., local), or by the processors in the position server 152 (i.e., remote). Displaying the current position of a client station at stage 710 is optional.

At stage 702, the client station 120 is configured to send an ANQP query request to a first access point 108, such that the client station is unattached from the first access point. The client station 120 may remain unattached throughout the process 700. For example, the ANQP query request may be sent prior to performing a wireless client association process with the first access point. The client station 120 may enter a geographic area that is within range of the first access point 108, and may be unattached from the access points in the wireless communication network 100. The client station 120 may perform an initial exchange with the first access point 108, and the first access point 108 may respond as an Independent Base Station (IBSS).

At stage 704, the client station 120 is configured to receive an ANQP query response including a neighbor report from the first access point. The ANQP query response is received by the unattached client station 120. For example, the ANQP query response and the corresponding neighbor report is provided to the client station 120 prior to forming an association between the first access point 108 and the client station 120. In an example, a neighbor report includes one or more neighbor record elements 510, 552 and each record element includes location information associated with an access point. The client station 120 is configured to parse the frames within the neighbor record elements to determine a list of neighboring access points that may be used for positioning. For example, the neighbor report may indicate that a second access point, a third access point, and a fourth access point (e.g., access points 102, 104, 106 respectively) should be within range of the client station 120. The order of the list of access points in the neighbor report may indicate to the client station 120 the order in which to attempt an FTM session with the respective access points. In an example, a field within the neighbor report may indicate a visitation order (e.g., visitation index, signal strength). The record elements may also include RTT and RSSI information for the neighbors. The neighbor record elements may be indexed based on the importance of the neighbor in a position calculation. For example, the neighbors may be indexed based on geometric orientation (i.e., triangulation) in an effort to improve the position calculation.

At stage 706, the client station 120 is configured to initiate one or more Fine Timing Measurement (FTM) Sessions with one or more access points based on the neighbor report. The client station 120 is configured to receive and capture information related to the FTM sessions (e.g., 310, 312, 314, 316) with the access points. The client station 120 may include a positioning unit configured to utilize the information included in the neighbor report in conjunction with FTM session information (e.g., RTT, RSSI, TOA, and TDOA data) to determine the current position of the client station at stage 708. The current position of the client station may be stored locally. Optionally, the client station 120 may be configured to display current position of the client station at stage 710.

Embodiments may take the form of an entirely hardware embodiment, an entirely software embodiment (including firmware, resident software, micro-code, etc.) or an embodiment combining software and hardware aspects that may all generally be referred to herein as an “apparatus,” “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to execute (e.g., perform) a process according to embodiments, whether presently described or not, since every conceivable variation is not enumerated herein. A machine-readable medium includes any mechanism for storing or transmitting information in a form (e.g., software, processing application) readable by a machine (e.g., a computer). A machine-readable medium may be a non-transitory processor-readable storage medium, a machine-readable storage medium, or a machine-readable signal medium. A machine-readable storage medium may include, for example, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of tangible medium suitable for storing electronic instructions. A machine-readable signal medium may include a propagated data signal with computer readable program code embodied therein, for example, an electrical, optical, acoustical, or other form of propagated signal (e.g., carrier waves, infrared signals, digital signals, etc.). Program code embodied on a machine-readable signal medium may be transmitted using any suitable medium, including, but not limited to, wireline, wireless, optical fiber cable, RF, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

Referring to FIG. 8A is a block diagram of one embodiment of an electronic device 800 for use in positioning utilizing ANQP neighbor reports. In some implementations, the electronic device 800 may be a client station 120 embodied in a device such as a notebook computer, a tablet computer, a netbook, a mobile phone, a smart phone, a gaming console, a personal digital assistant (PDA), or an inventory tag. The electronic device 800 may be other electronic systems such as a Home Node B (HNB) device with a wireless transceiver and positioning capabilities (e.g., a type of access point). The electronic device 800 includes a processor unit 802 (possibly including multiple processors, multiple cores, multiple nodes, and/or implementing multi-threading, etc.). The electronic device 800 includes a memory unit 806. The memory unit 806 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 800 also includes a bus 810 (e.g., PCI, ISA, PCI-Express, HyperTransport®, InfiniBand®, NuBus, AHB, AXI, etc.), and network interfaces 804 that include at least one of a wireless network interface (e.g., a WLAN interface, a Bluetooth® interface, a WiMAX interface, a ZigBee® interface, a Wireless USB interface, etc.) and a wired network interface (e.g., an Ethernet interface, etc.).

The electronic device 800 also includes a communication unit 808. The communication unit 808 comprises a positioning unit 812, a receiver 814, a transmitter 816, and one or more antennas 818. The transmitter 816, the antennas 818, and the receiver 814 form a wireless communication module (with the transmitter 816 and the receiver 814 being a transceiver 820). The transmitter 816 and the receiver 814 are configured to communicate bi-directionally with one or more client stations and other access points via a corresponding antenna 818. In some embodiments, the electronic device 800 can be configured as a WLAN station with positioning determining capabilities (e.g., a type of access point). The positioning unit 812 can utilize the FTM session information exchanged with the access points to determine RSS and/or TDOA timing information associated with the access points. The positioning unit 812 can determine the position of the electronic device 800 based, at least in part, on the TDOA timing information, and the AP position information, as described above with reference to FIGS. 1A, 1B, and 3-7. In some embodiments, the access points 102, 104, 106, 108 can also be configured as the electronic device 800 of FIG. 8A. In this embodiment, the access points can use their processing capabilities to execute their respective operations described above. Any one of these functionalities may be partially (or entirely) implemented in hardware and/or on the processor unit 802. For example, the functionality may be implemented with an application specific integrated circuit, in logic implemented in the processor unit 802, in a co-processor on a peripheral device or card, etc. Further, realizations may include fewer or additional components not illustrated in FIG. 8A (e.g., display screen, video cards, audio cards, additional network interfaces, peripheral devices, etc.). The processor unit 802, the memory unit 806, and the network interfaces 804 are coupled to the bus 810. Although illustrated as being coupled to the bus 810, the memory unit 806 may be coupled to the processor unit 802.

Referring to FIG. 8B, an example of a wireless transceiver system such as an access point 850 comprises a computer system including a processor 851, memory 852 including software 854, a transmitter 856, antennas 858, and a receiver 860. The access points 102, 104, 106, 108 may be configured as the access point 850 of FIG. 8B. The transmitter 856, antennas 858, and the receiver 860 form a wireless communication module (with the transmitter 856 and the receiver 860 being a transceiver 862). The transmitter 856 is connected to one of the antennas 858 and the receiver 860 is connected to another of the antennas 858. Other example access points may have different configurations, e.g., with only one antenna 858, and/or with multiple transmitters 856 and/or multiple receivers 860. The transmitter 856 and the receiver 860 are configured such that the access point 850 can communicate bi-directionally with the client station 120 via the antennas 858. The processor 851 is preferably an intelligent hardware device, e.g., a central processing unit (CPU) such as those made by ARM®, Intel® Corporation, or AMD®, a microcontroller, an application specific integrated circuit (ASIC), etc. The processor 851 could comprise multiple separate physical entities that can be distributed in the access point 850. The memory 852 includes random access memory (RAM) and read-only memory (ROM). The memory 852 is a processor-readable storage medium that stores the software 854 which is processor-readable, processor-executable software code containing processor-readable instructions that are configured to, when executed, cause the processor 851 to perform various functions described herein (although the description may refer only to the processor 851 performing the functions). Alternatively, the software 854 may not be directly executable by the processor 851 but configured to cause the processor 851, e.g., when compiled and executed, to perform the functions.

While the embodiments are described with reference to various implementations and exploitations, it will be understood that these embodiments are illustrative and that the scope of the inventive subject matter is not limited to them. In general, techniques for positioning with access network query protocol neighbor reports as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

As used herein, including in the claims, unless otherwise stated, a statement that a function or operation is “based on” an item or condition means that the function or operation is based on the stated item or condition and may be based on one or more items and/or conditions in addition to the stated item or condition.

Further, more than one invention may be disclosed.

1. A wireless transceiver system for providing a neighbor report in an Access Network Query Protocol (ANQP) query response message, comprising:
a memory;
a receiver to receive an ANQP query request, wherein the ANQP query request includes a request for the neighbor report;
at least one processor operably coupled to the memory and configured to:
determine neighbor position information;
receive the ANQP query request from an unattached client station; and
a transmitter to send an ANQP query response including the neighbor report to the unattached client station.

2. The wireless transceiver system of claim 1 wherein the at least one processor is configured to retrieve the neighbor position information from a remote server.

3. The wireless transceiver system of claim 1 further configured to receive a beacon transmission from a neighboring transceiver, wherein the at least one processor is configured to determine the neighbor position information based on the beacon transmission.

4. The wireless transceiver system of claim 1 wherein the neighbor report includes a visitation index.

5. The wireless transceiver system of claim 1 wherein the neighbor report includes a signal strength value associated with each of one or more neighboring access points included in the neighbor report.

6. The wireless transceiver system of claim 1 wherein the at least one processor is further configured to generate the neighbor report.

7. The wireless transceiver system of claim 1 wherein the at least one processor is further configured to retrieve the neighbor report from a remote server.

8. A method for providing a neighbor report in an Access Network Query Protocol (ANQP) query response message, comprising:
determining neighbor position information;
generating the neighbor report based on the neighbor position information;
receiving an ANQP query request from an unattached client station; and
sending an ANQP query response including the neighbor report to the unattached client station.

9. The method of claim 8 wherein determining the neighbor position information includes retrieving the neighbor position information from a remote server.

10. The method of claim 8 further comprising receiving a beacon transmission from a neighboring transceiver, wherein the beacon transmission includes position information associated with the neighboring transceiver.

11. The method of claim 8 wherein the neighbor report includes a visitation index.

12. The method of claim 8 wherein the neighbor report includes a signal strength value associated with each of one or more neighboring access points included in the neighbor report.

13. The method of claim 8 generating the neighbor report includes retrieving the neighbor report from a remote server.

14. A method of determining a location of a client station in a wireless network, comprising:
sending, with the client station, an Access Network Query Protocol (ANQP) query request to a first access point, wherein the client station is unattached from the first access point;
receiving, with the client station, an ANQP query response including a neighbor report from the first access point;
initiating, with the client station, one or more Fine Timing Measurement (FTM) sessions with one or more access points based on the neighbor report; and
determining the location of the client station based on the one or more FTM sessions.

15. The method of claim 14 wherein the neighbor report includes an ordered list of neighboring access points, and the one or more FTM sessions are initiated in a sequence based on the ordered list of neighboring access points.

16. The method of claim 15 wherein the ordered list of neighboring access points includes a visitation index and the one or more FTM sessions are initiated in a sequence based on the visitation index.

17. The method of claim 15 wherein the ordered list of neighboring access points includes a signal strength value associated with each of one or more neighboring access points included in the ordered list of neighboring access points, and FTM sessions are initiated in a sequence based on the signal strength value.

18. The method of claim 14 further comprising displaying the location on the client station.

19. The method of claim 14 further comprising determining Round Trip Time (RTT) information based on the one or more FTM sessions.

20. The method of claim 19 wherein determining the location of the client station based on the RTT information.

21. An apparatus, comprising:
a memory;
at least one processor operably coupled to the memory and configured to:
send an Access Network Query Protocol (ANQP) query request to a first access point, wherein the apparatus is unattached from the first access point;
receive an ANQP query response including a neighbor report from the first access point;
initiate one or more Fine Timing Measurement (FTM) sessions with one or more access points based on the neighbor report; and
determine a location of the apparatus based on the one or more FTM sessions.

22. The apparatus of claim 21 wherein the neighbor report includes an ordered list of neighboring access points, and processor is configured to initiate the one or more FTM sessions in a sequence based on the ordered list of neighboring access points.

23. The apparatus of claim 22 wherein the ordered list of neighboring access points includes a visitation index.

24. The apparatus of claim 22 wherein the ordered list of neighboring access points includes a signal strength value associated with each of one or more neighboring access points included in the ordered list of neighboring access points.

25. The apparatus of claim 21 further comprising a display screen, wherein the at least one processor is further configured to output the location to the display screen.

26. The apparatus of claim 21 wherein the at least one processor is further configured to determine Round Trip Time (RTT) information based on the one or more FTM sessions.

27. The apparatus of claim 26 wherein the at least one processor is further configured to determine the location of the apparatus based on the RTT information.
